(19) United States
(12) Patent Application Publication
(10) Pub. No.: US 2011/0199317 A1
(43) Pub. Date: Aug. 18, 2011

(54) Touch Screen

(76) Inventors: Sang Hwa KIM, Gyunggi-do (KR); Yong Soo Oh, Gyunggi-do (KR); Jong Young Lee, Gyunggi-do (KR); Ho Joon Park, Seoul (KR)

(21) Appl. No.: 12/780,737

(22) Filed: May 14, 2010

(30) Foreign Application Priority Data
Feb. 16, 2010 (KR) 10-2010-0013849

(51) Int. Cl. G06F 3/041

(52) U.S. Cl. 345/173

(57) ABSTRACT

Disclosed herein is a touch screen, including: a liquid crystal layer including a localized polymer layer formed on a surface thereof; and transparent electrodes disposed on both sides of the liquid crystal layer. The touch screen can be used as an integral touch screen without optical and physical losses because a localized polymer layer is formed on the surface of a liquid crystal layer, can improve durability and obtain high-speed response characteristics in liquid crystal behavior because a uniform polymer layer formed in a liquid crystal layer, and can improve durability without increasing thickness or additionally forming a protective film and does not deteriorate intrinsic display properties such as light and darkness ratio (LD ratio), response characteristics and the like, because a localized polymer layer is formed on the surface of a liquid crystal layer.

### CROSS REFERENCE TO RELATED APPLICATION

This application claims the benefit of Korean Patent Application No. 10-2010-0013849, filed Feb. 16, 2010, entitled “Touch screen”, which is hereby incorporated by reference in its entirety into this application.

### BACKGROUND OF THE INVENTION

1. Technical Field

The present invention relates to a touch screen including a liquid crystal layer having a localized polymer layer.

2. Description of the Related Art

Recently, a touch screen for inputting signals into electronic products by touch has been generally used according to users' requirements for conveniently using electronic products. A touch screen has many advantages that it can easily work together with IT equipment in addition to the advantages that space can be saved, operability and convenience can be improved, and specifications can be easily changed, thus increasing the recognition of users. Due to these advantages, a touch screen is widely used in various fields, such as industry, transportation, service, medical, mobile and the like.

Further, a touch screen can be manufactured by various methods, such as a resistive overlay method in which a glass substrate is coated with resistive components and then covered with a polyethylene film, a capacitive overlay method in which a transparent conductive metal is applied on both sides of a heat-treated reinforced glass substrate, an integral overlay method in which infrared luminescence diodes emitting infrared beams and strain gauges measuring the extensibility of four corners of a substrate are used, a surface ultrasonic conductive overlay method in which an ultrasonic transmitter disposed at one edge of a glass substrate, an ultrasonic receiver disposed at the other edge of the glass substrate and ultrasonic reflectors disposed between the ultrasonic transmitter and the ultrasonic receiver at regular intervals are used, and a piezoelectric overlay method in which a pressure-sensitive crystal oscillator is provided at the corner of a display panel in order to detect touch.

Further, a touch screen manufactured by attaching a touch panel onto a display panel using an adhesive film is widely used. However, such a touch screen has many problems, such as increase of thickness, decrease of transmissivity and the like. Therefore, in order to solve the above problems, an integral touch screen in which a touch panel is integrated with a display panel is being developed.

Such an integral touch screen has many advantages in optical, physical and economical aspects, but is also problematic in that, when users touch a touch screen, the touch screen is directly brought into contact with the users, so that a display panel is directly pressed, thereby distorting images and deteriorating durability.

More concretely, FIG. 1 is a schematic sectional view showing a display panel of a conventional integral touch screen. As shown in FIG. 1, the display panel 100 includes a liquid crystal layer 110, ITO glass layers 120 formed on both sides of the liquid crystal layer 110, and protective films 130 respectively formed on the ITO glass layers 120. Therefore, the conventional integral touch screen including the display panel 100 is problematic in that its thickness is increased by the protective films 130, thus deteriorating display properties such as contrast ratio, transmissivity and the like.

### SUMMARY OF THE INVENTION

Accordingly, the present invention has been made to solve the above-mentioned problems, and the present invention provides a touch screen which can be used as an integral touch screen without optical and physical losses because a localized polymer layer is formed on the surface of a liquid crystal layer.

Further, the present invention provides a touch screen which can improve durability and obtain high-speed response characteristics in liquid crystal behavior because a uniform polymer layer is formed on a liquid crystal layer.

Further, the present invention provides a touch screen which can improve durability without increasing thickness or additionally forming a protective film and does not deteriorate intrinsic display properties such as contrast ratio, response characteristics and the like, because a localized polymer layer is formed on the surface of a liquid crystal layer.

An aspect of the present invention provides a touch screen, including: a liquid crystal layer including a localized polymer layer formed on a surface thereof; and transparent electrodes disposed on both sides of the liquid crystal layer.

Here, the liquid crystal layer may include a liquid crystal material layer and a polymer layer, and the polymer layer may be formed on one side or both sides of the liquid crystal material layer.

Further, the liquid crystal material layer may have a thickness of 2˜5 μm, the polymer layer may have a thickness of 0.1˜0.25 μm, and the transparent electrodes may have a thickness of 500˜700 μm.

Further, the liquid crystal layer may include 95˜99.9 wt % of a liquid crystal material and 0.1˜5 wt % of a polymer.

Further, the localized polymer layer may be formed by adding monomers to a liquid crystal composition and then irradiating the monomers with UV to polymerize the monomers, and the UV irradiation may be performed at a UV intensity of 0.8 mW/cm² for 3˜7 minutes.

Further, the transparent electrode may be made of ITO glass or a conductive polymer.

Further, a polymer constituting the polymer layer may be at least one selected from among polyacrylate, polyester, polyurethane, polyether, polycarboxylate and polyamide, and the polymer may be a liquid crystalline polymer.

Another aspect of the present invention provides a touch screen, including: a display panel; and a touch panel formed on the display panel, wherein the display panel includes: an upper substrate; a lower substrate facing the upper substrate; transparent electrodes formed on opposed surfaces of the upper substrate and the lower substrate; and a liquid crystal layer formed between the transparent electrodes, the liquid crystal layer including a localized polymer layer formed on a surface thereof.

Here, the localized polymer layer may be formed on one side or both sides of the liquid crystal layer.

Further, the display panel may further include polyimide layers formed on both sides of the liquid crystal layer, the polyimide layers being disposed between the transparent electrodes. Further, the display panel may further include a spacer disposed at an outside of the liquid crystal layer to provide a space for accommodating the liquid crystal layer.

Further, the touch panel may include: a transparent electrode formed on the display panel; dot spacers and air gap formed on the transparent electrode; a transparent electrode formed on the air gap; and an upper substrate formed on the transparent electrode.

Further, the touch panel may further include double-sided adhesive tape formed at lateral sides of the dot spacers and the air gap.

Further, the touch screen may further include polarizing plates formed at a lower end of the display panel and at an upper end of the touch panel.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic sectional view showing a display panel of a conventional integral touch screen;

FIG. 2 is a schematic sectional view showing a liquid crystal cell of a touch screen according to the present invention;

FIG. 3 is a schematic sectional view illustrating a procedure and result of forming a polymer layer on the surface of a liquid crystal layer of a touch screen according to the present invention;

FIG. 4 is a schematic sectional view showing a touch screen according to an embodiment of the present invention; and

FIG. 5 is a schematic sectional view showing a touch screen according to another embodiment of the present invention.

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

FIG. 2 is a schematic sectional view showing a liquid crystal cell of a touch screen according to the present invention. As shown in FIG. 2, the liquid crystal cell 200 of the touch screen includes a liquid crystal layer 210 and transparent electrodes 220. The transparent electrodes 220 are formed on both sides of the liquid crystal layer 210.

The liquid crystal layer 210 includes a liquid crystal material layer 211 and at least one polymer layer 212. The polymer layer 212 may be formed on only one side of the liquid crystal material layer 211 or may be formed on both sides thereof. It is shown in FIG. 2 that the polymer layers 212 are formed on both sides of the liquid crystal material layer 211.

Concretely, the liquid crystal material layer 211 may have a thickness of 2˜5 μm, and the polymer layer 212 may have a thickness of 0.1˜0.25 μm. Further, the transparent electrode may have a thickness of 500˜700 μm.

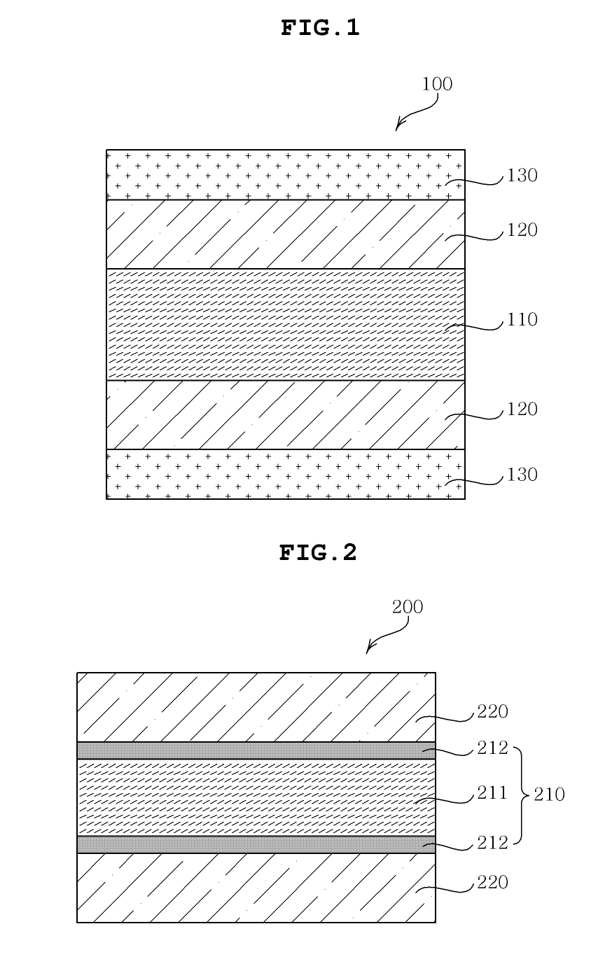

As described above, since the liquid crystal cell of the touch screen according to the present invention does not include a protective film compared to the conventional touch screen shown in FIG. 1, the thickness of the touch screen of the present invention is decreased by about 10˜400 μm, the durability thereof is improved, and the intrinsic display properties thereof, such as contrast ratio, response characteristics and the like, is not deteriorated.

Further, the transparent electrode is made of ITO glass or a conductive polymer.

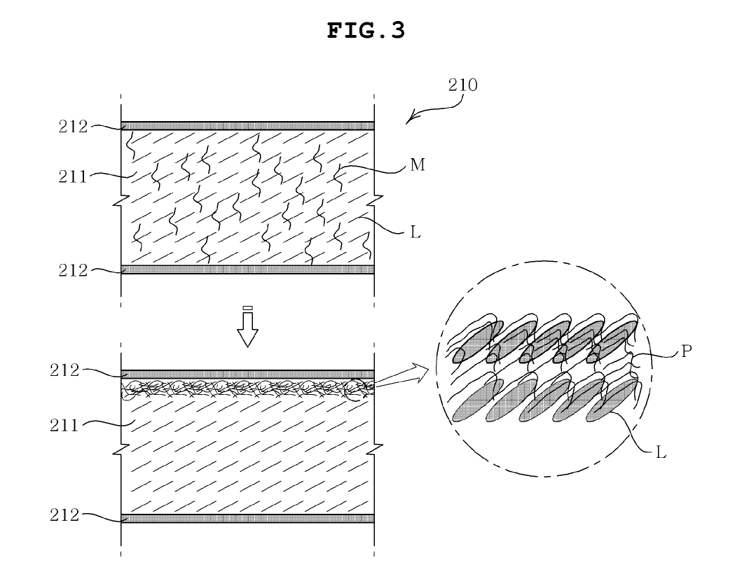

FIG. 3 is a schematic sectional view illustrating a procedure and result of forming a polymer layer on the surface of a liquid crystal layer of a touch screen according to the present invention. As shown in FIG. 3, the polymer layer 212 is formed on the surface of the liquid crystal layer 210 by adding monomers (M) to a liquid crystal composition (L) and then polymerizing the monomers (M) by UV irradiation to locally form polymers (P) on the surface of the liquid crystal layer 211.

The condition and result of forming the polymer layer on the surface of the liquid crystal layer depending on the intensity and time of UV irradiation are given in Table 1 below.

TABLE 1

| | UV intensity | Irradiation | Polymerized | Thickness of | | |
|---|---|---|---|---|---|---|
| Tests | (mW/cm²) | time (min) | region | polymer layer | Contrastratio | Durability |
| 1 | 0.1 | 10 | entire | uniform | 500:1 | middle |
| 2 | 0.8 | 1 | surface- | nonuniform | 2000:1 | low |
| | | | localized | | | |
| 3 | 0.8 | 5 | surface- | uniform | 2000:1 | high |
| | | | localized | | | |
| 4 | 0.8 | 10 | surface- | uniform | 1500:1 | high |
| | | | localized | | | |
| 5 | 5 | 1 | surface- | nonuniform | 2000:1 | low |
| | | | localized | | | |
| 6 | 10 | 1 | surface- | nonuniform | 2000:1 | low |
| | | | localized | | | |

It can be seen from Test 1 of Table 1 that, when UV irradiation is performed at a UV intensity of 0.1 mW/cm² for 10 minutes, a polymer layer is formed entirely, not surface-locally, and that the contrast ratio of the formed polymer layer is decreased although the thickness thereof is uniform. Further, it can be seen from Test 2 of Table 1 that, when UV irradiation is performed at a UV intensity of 0.8 mW/cm² for 1 minute and thus the irradiation time is insufficient, polymerization is not completely conducted, so that the thickness of the formed polymer layer is not uniform and the durability thereof is not good. Further, it can be seen from Tests 5 and 6 of Table 1 that, when UV irradiation is performed at a strong UV intensity of 5 or 10 mW/cm² for a short period of time of 1 minute, a surface-localized polymer layer is formed, whereas the thickness of the formed polymer layer is not uniform and the durability thereof is not good.

In conclusion, as shown in Test 3 of Table 1, when UV irradiation is performed at a strong UV intensity of 0.8 mW/cm² for a short period of time of 5 minutes, the thickness of the formed polymer layer is uniform, thus forming a liquid crystal layer having excellent durability. Therefore, it is preferred that the UV irradiation be performed at a strong UV intensity of 0.8 mW/cm² for a short period of time of 3˜7 minutes.

The characteristics of the liquid crystal layer depending on the polymer content thereof are given in Table 2 below.

TABLE 2

| | Polymer | Contrast | Response speed | |
|---|---|---|---|---|
| Tests | content (wt %) | ratio | (m/s) | Notes |
| 1 | 0.1 | 2000:1 | 3 | |
| 2 | 1 | 2000:1 | 3 | |
| 3 | 3 | 2000:1 | 3 | |
| 4 | 5 | 1000:1 | 3 | |
| 5 | 8 | 100:1 | 10 | contrast ratio and |
| | | | | response speed are |
| | | | | decreased |
| 6 | 10 | 20:1 | 20 | contrast ratio and |
| | | | | response speed are |
| | | | | decreased |

It can be seen from Test 4 of Table 2 that, when the polymer content is 5 wt % or more, the contrast ratio is decreased. Further, it can be seen from Test 5 of Table 2 that, when the polymer content is 8 wt % or more, the contrast ratio is rapidly decreased. In conclusion, the liquid crystal layer of the present invention may include 95˜99.9 wt % of liquid crystal and 0.1˜5 wt % of a polymer.

The polymer constituting the polymer layer is not limited to a specific polymer, and may be at least one polymer selected from among polyacrylate, polyester, polyurethane, polyether, polycarboxylate, and polyamide.

Further, considering the combination of the polymer and liquid crystal, the polymer may be a liquid crystalline polymer.

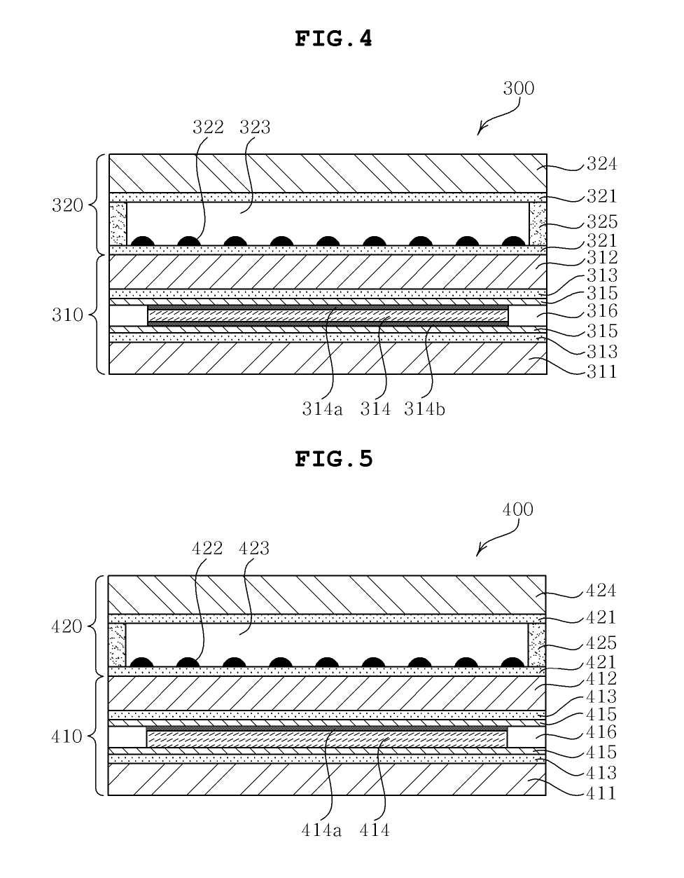

FIG. 4 is a schematic sectional view showing a touch screen according to an embodiment of the present invention. As shown in FIG. 4, the touch screen 300 includes a display panel 310 and a touch panel 320. Here, the display panel 310 includes an upper substrate 311, a lower substrate 312, transparent electrodes 313, a liquid crystal layer 314, polyimide layers 315, and a spacer 316.

Here, the lower substrate 312 faces the upper substrate 311, and the transparent electrodes 313 are formed on the opposed surfaces of the upper substrate 311 and the lower substrate 312, respectively. Further, the liquid crystal layer 314 is formed between the transparent electrodes 313, and localized polymer layers 314a and 314b are formed on both sides of the liquid crystal layer 314. Further, the polyimide layers 315 are formed on the localized polymer layers 314a and 314b, respectively. The spacer 316 is provided therein with the liquid crystal layer 314, and serves to accommodate the liquid crystal layer.

The touch panel 320 includes transparent electrodes 321, dot spacers 322, an air gap 323, an upper substrate 324, and double-sided adhesive tape (DAT) 325.

One of the transparent electrodes 321 is formed on the display panel 310, and the dot spacers 322 and the air gap 323 are formed on this transparent electrode 321. Further, the other transparent electrode 321 is formed on the air gap 323, and the upper substrate 324 is formed on this transparent electrode 321.

Further, the double-sided adhesive tape is formed at the lateral sides of the dot spacers and the air gap.

Meanwhile, the touch screen 300 according to an embodiment of the present invention may include polarizing plates (not shown) respectively formed at the lower end of the display panel 310 and at the upper end of the touch panel 320.

FIG. 5 is a schematic sectional view showing a touch screen according to another embodiment of the present invention. As shown in FIG. 5, the touch screen 400, compared to the touch screen 300 shown in FIG. 4, is characterized in that a localized polymer layer 414a is formed on only one side of a liquid crystal layer 414.

Concretely, the touch screen 400 includes a display panel 410 and a touch panel 420. Here, the display panel 410 includes an upper substrate 411, a lower substrate 412, transparent electrodes 413, a liquid crystal layer 414, polyimide layers 415, and a spacer 416. Further, the touch panel 420 includes transparent electrodes 421, dot spacers 422, an air gap 423, an upper substrate 424, and double-sided adhesive tape (DAT) 425. The respective constituents shown in FIG. 5 and the technical features attributable to the combinations thereof are identical with those shown in FIG. 4.

As described above, according to the touch screen of the present invention, the touch screen can be used as an integral touch screen without optical and physical losses because a localized polymer layer is formed on the surface of a liquid crystal layer, can improve durability and obtain high-speed response characteristics in liquid crystal behavior because a uniform polymer layer formed in a liquid crystal layer, and can improve durability without increasing thickness or additionally forming a protective film and does not deteriorate intrinsic display properties such as light and darkness ratio (LD ratio), response characteristics and the like, because a localized polymer layer is formed on the surface of a liquid crystal layer.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. A touch screen, comprising:
a liquid crystal layer including a localized polymer layer formed on a surface thereof; and
transparent electrodes disposed on both sides of the liquid crystal layer.

2. The touch screen according to claim 1, wherein the liquid crystal layer includes a liquid crystal material layer and a polymer layer.

3. The touch screen according to claim 2, wherein the polymer layer is formed on one side of the liquid crystal material layer.

4. The touch screen according to claim 2, wherein the polymer layer is formed on both sides of the liquid crystal material layer.

5. The touch screen according to claim 2, wherein the liquid crystal material layer has a thickness of 2˜5 μm, and the polymer layer has a thickness of 0.1˜0.25 μm.

6. The touch screen according to claim 1, wherein the liquid crystal layer includes a liquid crystal material layer and a polymer layer, the liquid crystal material layer having a thickness of 2˜5 μm, the polymer layer having a thickness of 0.1˜0.25 μm and the transparent electrodes having a thickness of 500˜700 μm.

7. The touch screen according to claim 2, wherein the liquid crystal layer includes 95˜99.9 wt % of a liquid crystal material and 0.1˜5 wt % of a polymer.

8. The touch screen according to claim 1, wherein the localized polymer layer is formed by adding monomers to a liquid crystal composition and then irradiating the monomers with UV to polymerize the monomers.

9. The touch screen according to claim 8, wherein the UV irradiation is performed at a UV intensity of 0.8 mW/cm² for 3˜7 minutes.

10. The touch screen according to claim 1, wherein the transparent electrode is made of ITO glass or a conductive polymer.

11. The touch screen according to claim 1, wherein a polymer constituting the polymer layer is at least one selected from among polyacrylate, polyester, polyurethane, polyether, polycarboxylate, and polyamide.

12. The touch screen according to claim 11, wherein the polymer is a liquid crystalline polymer.

13. A touch screen, comprising:
a display panel; and
a touch panel formed on the display panel,
wherein the display panel includes:
an upper substrate;
a lower substrate facing the upper substrate;
transparent electrodes formed on opposed surfaces of the upper substrate and the lower substrate; and
a liquid crystal layer formed between the transparent electrodes, the liquid crystal layer including a localized polymer layer formed on a surface thereof.

14. The touch screen according to claim 13, wherein the localized polymer layer is formed on one side or both sides of the liquid crystal layer.

15. The touch screen according to claim 13, wherein the display panel further includes polyimide layers formed on both sides of the liquid crystal layer, the polyimide layers being disposed between the transparent electrodes.

16. The touch screen according to claim 13, wherein the display panel further includes a spacer disposed at an outside of the liquid crystal layer to provide a space for accommodating the liquid crystal layer.

17. The touch screen according to claim 13, wherein the touch panel includes:
a transparent electrode formed on the display panel;
dot spacers and air gap formed on the transparent electrode;
a transparent electrode formed on the air gap; and
an upper substrate formed on the transparent electrode.

18. The touch screen according to claim 17, wherein the touch panel further includes double-sided adhesive tape formed at lateral sides of the dot spacers and the air gap.

19. The touch screen according to claim 13, further comprising polarizing plates formed at a lower end of the display panel and at an upper end of the touch panel.
